(19) United States
(12) Patent Application Publication
(10) Pub. No.: US 2025/0372037 A1
(43) Pub. Date: Dec. 4, 2025

(54) DISPLAY DEVICE AND ELECTRONIC APPARATUS INCLUDING THE SAME

(71) Applicant: Samsung Display Co., LTD., Yongin-si (KR)

(72) Inventors: MINJOO KIM, Yongin-si (KR); CHULKYU KANG, Yongin-si (KR); MINWOO BYUN, Yongin-si (KR); SEONI JEONG, Yongin-si (KR); JI-HYUN KA, Yongin-si (KR); WONKYU KWAK, Yongin-si (KR); KYONGHWAN OH, Yongin-si (KR); JAE-SIC LEE, Yongin-si (KR)

(73) Assignee: Samsung Display Co., LTD., Yongin-si (KR)

(21) Appl. No.: 19/079,801

(22) Filed: Mar. 14, 2025

(30) Foreign Application Priority Data
Jun. 3, 2024 (KR) 10-2024-0072250

(51) Int. Cl. G09G 3/3233; G09G 3/32; G09G 3/3275

(52) U.S. Cl. CPC G09G 3/3233; G09G 3/32; G09G 3/3275; G09G 2300/0819; G09G 2300/0852; G09G 2300/0861; G09G 2310/0202; G09G 2310/0291; G09G 2310/0297; G09G 2310/08; G09G 2330/021

(57) ABSTRACT

A display device includes a first pixel connected to a first scan line which transmits a first scan signal and a first data line, a second pixel connected to the first scan line and a second data line, a data driver including an output buffer which outputs a data signal to an output line, and a demultiplexer including a first transistor connected between the first data line and the output line and turned-on in response to a first control signal, and a second transistor connected between the second data line and the output line and turned-on in response to a second control signal. A difference between a turn-on voltage level and a turn-off voltage level of each of the first and second control signals is less than a difference between a turn-on voltage level and a turn-off voltage level of the first scan signal.

### CROSS-REFERENCE TO RELATED APPLICATION(S)

This application claims priority to and benefits of Korean Patent Application No. 10-2024-0072250 under 35 USC § 119, filed on Jun. 3, 2024, in the Korean Intellectual Property Office (KIPO), the entire contents of which are incorporated herein by reference.

### BACKGROUND

### 1. Technical Field

Embodiments relate to a display device. More particularly, embodiments relate to a display device in which a dead space is reduced and an electronic apparatus including the display device.

### 2. Description of the Related Art

A display device may include a display panel and a data driver. The display panel may include pixels and data lines that provide data signals to the pixels. The data driver may include output buffers that output the data signals to the data lines.

The display device may further include a demultiplexer that connects the data lines and the output buffers in a many-to-one manner. As the display device includes the demultiplexer, the number of output buffers included in the data driver may be reduced, and an area of the data driver may be reduced. Accordingly, a dead space of the display device may be reduced.

### SUMMARY

Embodiments provide a display device in which power consumption is reduced and an electronic apparatus including the display device.

However, embodiments are not limited to those set forth herein. The above and other embodiments will become more apparent to one of ordinary skill in the art to which the disclosure pertains by referencing the detailed description of the disclosure given below.

A display device according to embodiments may include a first pixel connected to a first scan line which transmits a first scan signal and a first data line, a second pixel connected to the first scan line and a second data line, a data driver including an output buffer which outputs a data signal to an output line, and a demultiplexer including a first transistor connected between the first data line and the output line and turned-on in response to a first control signal, and a second transistor connected between the second data line and the output line and turned-on in response to a second control signal. A difference between a turn-on voltage level and a turn-off voltage level of each of the first and second control signals may be less than a difference between a turn-on voltage level and a turn-off voltage level of the first scan signal.

In an embodiment, the turn-off voltage level of each of the first and second control signals may be higher than the turn-off voltage level of the first scan signal.

In an embodiment, the turn-on voltage level of each of the first and second control signals may be lower than the turn-on voltage level of the first scan signal.

In an embodiment, a frame period may include an address scan period in which the data signal is applied to the first and second data lines, and a self-scan period in which the data signal is not applied to the first and second data lines. Each of the first and second control signals may toggle between the turn-on voltage level and the turn-off voltage level with a first toggling duration in the address scan period.

In an embodiment, each of the first and second control signals may have the turn-off voltage level in the self-scan period.

In an embodiment, each of the first and second control signals may toggle between the turn-on voltage level and the turn-off voltage level with a second toggling duration greater than the first toggling duration in the self-scan period.

In an embodiment, the display device may further include a third pixel connected to a second scan line which transmits a second scan signal and the first data line, and a fourth pixel connected to the second scan line and the second data line. In a first horizontal period in which the first scan signal has the turn-on voltage level, the second control signal may have the turn-on voltage level after the first control signal has the turn-on voltage level. In a second horizontal period in which the second scan signal has a turn-on voltage level, the first control signal may have the turn-on voltage level after the second control signal has the turn-on voltage level.

In an embodiment, in each of the first and second horizontal periods, a first width of a period in which the first control signal has the turn-on voltage level may be different from a second width of a period in which the second control signal has the turn-on voltage level.

In an embodiment, the first width may be greater than the second width in the first horizontal period.

In an embodiment, the second width may be greater than the first width in the second horizontal period.

In an embodiment, a period in which the first control signal has the turn-on voltage level may not overlap a period in which the second control signal has the turn-on voltage level.

In an embodiment, each of the first and second pixels may include a driving transistor including a gate electrode connected to a first node, a first electrode connected to a second node, and a second electrode connected to a third node, a writing transistor including a gate electrode which receives a first scan signal, a first electrode which receives the data signal, and a second electrode connected to the first node, a reference transistor including a gate electrode which receives a reference gate signal, a first electrode which receives a reference voltage, and a second electrode connected to the first node, an initialization transistor including a gate electrode which receives an initialization gate signal, a first electrode which receives an initialization voltage, and a second electrode connected to the third node, an emission transistor including a gate electrode which receives an emission signal, a first electrode which receives a first power voltage, and a second electrode connected to the second node, a storage capacitor including a first electrode connected to the first node and a second electrode connected to the third node, a hold capacitor including a first electrode which receives the first power voltage and a second electrode connected to the third node, and a light-emitting element including a first electrode connected to the third node and a second electrode which receives a second power voltage.

A display device according to embodiments may include a first pixel connected to a first scan line which transmits a first scan signal and a first data line, a second pixel connected to the first scan line and a second data line, a third pixel connected to a second scan line which transmits a second scan signal and the first data line, a fourth pixel connected to the second scan line and the second data line, a data driver including an output buffer which outputs a data signal to an output line, and a demultiplexer including a first transistor connected between the first data line and the output line and turned-on in response to a first control signal, and a second transistor connected between the second data line and the output line and turned-on in response to a second control signal. In a first horizontal period in which the first scan signal has a turn-on voltage level, the second control signal may have a turn-on voltage level after the first control signal has a turn-on voltage level. In a second horizontal period in which the second scan signal has a turn-on voltage level, the first control signal may have the turn-on voltage level after the second control signal has the turn-on voltage level.

In an embodiment, a frame period may include an address scan period in which the data signal is applied to the first and second data lines, and a self-scan period in which the data signal is not applied to the first and second data lines. Each of the first and second control signals may toggle between the turn-on voltage level and a turn-off voltage level with a first toggling duration in the address scan period.

In an embodiment, each of the first and second control signals may have the turn-off voltage level in the self-scan period.

In an embodiment, each of the first and second control signals may toggle between the turn-on voltage level and the turn-off voltage level with a second toggling duration greater than the first toggling duration in the self-scan period.

In an embodiment, in each of the first and second horizontal periods, a first width of a period in which the first control signal has the turn-on voltage level may be different from a second width of a period in which the second control signal has the turn-on voltage level.

In an embodiment, the first width may be greater than the second width in the first horizontal period.

In an embodiment, the second width may be greater than the first width in the second horizontal period.

In an electronic apparatus including a display device which displays an image and a processor which controls the display device according to embodiments, the display device may include a first pixel connected to a first scan line which transmits a first scan signal and a first data line, a second pixel connected to the first scan line and a second data line, a data driver including an output buffer which outputs a data signal to an output line, and a demultiplexer including a first transistor connected between the first data line and the output line and turned-on in response to a first control signal, and a second transistor connected between the second data line and the output line and turned-on in response to a second control signal. A difference between a turn-on voltage level and a turn-off voltage level of each of the first and second control signals may be less than a difference between a turn-on voltage level and a turn-off voltage level of the first scan signal.

In the display device and the electronic apparatus according to the embodiments, the difference between the turn-on voltage level and the turn-off voltage level of the first and second control signals of the demultiplexer may decrease, the order in which the first and second control signals have the turn-on voltage level may alternately change in units of horizontal periods, or, in the self-scan period, the first and second control signals may have the turn-off voltage level or a toggling duration of the first and second control signals may increase, and thus, power consumption of the demultiplexer may be reduced, and the power consumption of the display device may be reduced.

Further, in the horizontal period, the width of the period in which the first control signal has the turn-on voltage level may be different from the width of the period in which the second control signal has the turn-on voltage level, and thus, a voltage deviation between data voltages may be reduced.

### BRIEF DESCRIPTION OF THE DRAWINGS

Illustrative, non-limiting embodiments will be more clearly understood from the following detailed description taken in conjunction with the accompanying drawings.

FIG. 1 is a schematic block diagram showing a display device according to an embodiment.

FIG. 2 is a schematic diagram of an equivalent circuit of an example of a pixel included in the display device of FIG. 1.

FIG. 3 is a schematic view showing a portion of the display device of FIG. 1.

FIG. 4 is a schematic view for describing a method of driving the display device of FIG. 1.

FIG. 5 is a timing diagram showing signals in an address scan period according to an embodiment.

FIG. 6 is a timing diagram showing signals in a self-scan period according to an embodiment.

FIG. 7 is a timing diagram showing signals in a self-scan period according to an embodiment.

FIG. 8 is a schematic block diagram showing an electronic apparatus according to an embodiment.

### DETAILED DESCRIPTION OF THE EMBODIMENTS

In the following description, for the purposes of explanation, numerous specific details are set forth in order to provide a thorough understanding of various embodiments or implementations of the invention. As used herein, “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the scope of the invention.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element or a layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the axis of the first direction D1, the axis of the second direction D2, and the axis of the third direction D3 are not limited to three axes of a rectangular coordinate system, such as the X, Y, and Z-axes, and may be interpreted in a broader sense. For example, the axis of the first direction D1, the axis of the second direction D2, and the axis of the third direction D3 may be perpendicular to one another, or may represent different directions that are not perpendicular to one another. For the purposes of this disclosure, “at least one of A and B” may be understood to mean A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the invention. Further, the blocks, units, and/or modules of some embodiments may be physically combined into more complex blocks, units, and/or modules without departing from the scope of the invention.

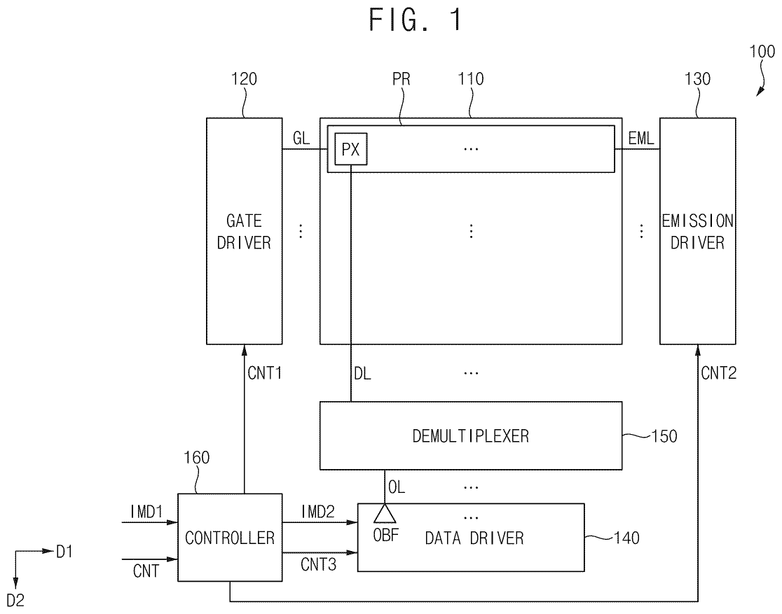

FIG. 1 is a schematic block diagram showing a display device 100 according to an embodiment.

Referring to FIG. 1, a display device 100 may include a display panel 110, a gate driver 120, an emission driver 130, a data driver 140, a demultiplexer 150, and a controller 160.

The display panel 110 may include pixel rows PR, gate lines GL, emission lines EML, and data lines DL. The pixel rows PR may extend in a first direction D1, and may be arranged in a second direction D2 intersecting the first direction D1. Each of the pixel rows PR may include pixels PX.

The gate lines GL may extend in the first direction D1, and may be arranged in the second direction D2. The gate lines GL may transmit gate signals.

The emission lines EML may extend in the first direction D1, and may be arranged in the second direction D2. The emission lines EML may transmit emission signals.

The data lines DL may extend in the second direction D2, and may be arranged in the first direction D1. The data lines DL may transmit data signals.

The pixels PX may be connected to the gate lines GL, the emission lines EML, and the data lines DL. The pixels PX may display an image based on the gate signals, the emission signals, and the data signals.

The gate driver 120 may output the gate signals to the gate lines GL. The gate driver 120 may generate the gate signals based on a gate control signal CNT1. The gate control signal CNT1 may include a gate clock signal, a gate start signal, etc.

The emission driver 130 may output the emission signals to the emission lines EML. The emission driver 130 may generate the emission signals based on an emission control signal CNT2. The emission control signal CNT2 may include an emission clock signal, an emission start signal, etc.

The data driver 140 may output the data signals to output lines OL. The data driver 140 may include output buffers OBF that output the data signals to the output lines OL. The data driver 140 may generate the data signals based on second image data IMD2 and a data control signal CNT3. The second image data IMD2 may include grayscale values corresponding to the pixels PX. The data control signal CNT3 may include an output data enable signal, a horizontal start signal, a load signal, etc.

The demultiplexer 150 may selectively connect the output lines OL to the data lines DL. The demultiplexer 150 may include transistors for selectively and electrically connecting the output lines OL to the data lines DL.

The number of output lines OL may be smaller than the number of data lines DL, and the demultiplexer 150 may connect the data lines and the output buffers in a many-to-one manner. In an embodiment, the number of output lines OL may be half the number of data lines DL, and the demultiplexer 150 may connect the data lines and the output buffers in a two-to-one manner.

The controller 160 may control an operation (or driving) of the gate driver 120, an operation (or driving) of the emission driver 130, and an operation (or driving) of the data driver 140. The controller 160 may output the gate control signal CNT1 to the gate driver 120, may output the emission control signal CNT2 to the emission driver 130, and may output the second image data IMD2 and the data control signal CNT3 to the data driver 140. The controller 160 may generate the gate control signal CNT1, the emission control signal CNT2, the second image data IMD2, and the data control signal CNT3 based on first image data IMD1 and a controller control signal CNT. The first image data IMD1 may include grayscale values corresponding to the pixels PX. The controller control signal CNT may include a master clock signal, a vertical start signal, a horizontal start signal, an input data enable signal, etc.

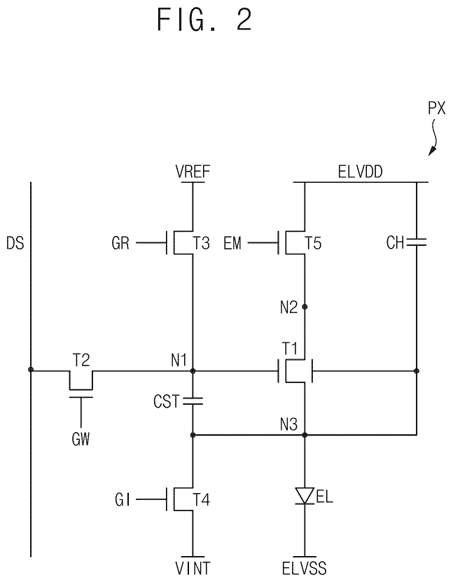

FIG. 2 is a schematic diagram of an equivalent circuit of an example of the pixel PX included in the display device 100 of FIG. 1.

Referring to FIG. 2, the pixel PX may include a driving transistor T1, a writing transistor T2, a reference transistor T3, an initialization transistor T4, an emission transistor T5, a storage capacitor CST, a hold capacitor CH, and a light-emitting element EL. In an embodiment, the gate signal may include a scan signal GW (or a writing gate signal), a reference gate signal GR, and an initialization gate signal GI.

The driving transistor T1 may include a gate electrode connected to a first node N1, a first electrode connected to a second node N2, and a second electrode connected to a third node N3. In an embodiment, the driving transistor T1 may further include a back gate electrode or a bottom gate electrode connected to the third node N3. The driving transistor T1 may control a driving current flowing through the light-emitting element EL.

The writing transistor T2 may include a gate electrode receiving the scan signal GW, a first electrode receiving the data signal DS, and a second electrode connected to the first node N1. The writing transistor T2 may transmit the data signal DS to the first node N1.

The reference transistor T3 may include a gate electrode receiving the reference gate signal GR, a first electrode receiving a reference voltage VREF, and a second electrode connected to the first node N1. The reference transistor T3 may initialize the first node N1.

The initialization transistor T4 may include a gate electrode receiving the initialization gate signal GI, a first electrode receiving an initialization voltage VINT, and a second electrode connected to the third node N3. The initialization transistor T4 may initialize the third node N3.

The emission transistor T5 may include a gate electrode receiving the emission signal EM, a first electrode receiving a first power voltage ELVDD, and a second electrode connected to the second node N2. The emission transistor T5 may form a current path between a line transmitting the first power voltage ELVDD and a line transmitting a second power voltage ELVSS.

In an embodiment, each of the driving transistor T1, the writing transistor T2, the reference transistor T3, the initialization transistor T4, and the emission transistor T5 may be an N-type transistor (e.g., an NMOS transistor). In an embodiment, each of the driving transistor T1, the writing transistor T2, the reference transistor T3, the initialization transistor T4, and the emission transistor T5 may be an oxide semiconductor transistor.

The storage capacitor CST may include a first electrode connected to the first node N1 and a second electrode connected to the third node N3. The storage capacitor CST may store a voltage of the first node N1.

The hold capacitor CH may include a first electrode receiving the first power voltage ELVDD and a second electrode connected to the third node N3. The hold capacitor CH may store a voltage of the third node N3.

Although FIG. 2 illustrates an embodiment in which the pixel PX includes five transistors and two capacitors, embodiments are not limited thereto. In another embodiment, the pixel PX may include two to four or six or more transistors and/or one or three or more capacitors.

The light-emitting element EL may include a first electrode connected to the third node N3 and a second electrode receiving the second power voltage ELVSS. In an embodiment, the light-emitting element EL may be an organic light-emitting diode. In another embodiment, the light-emitting element EL may be an inorganic light-emitting diode, a micro light-emitting diode, a quantum dot light-emitting diode, etc.

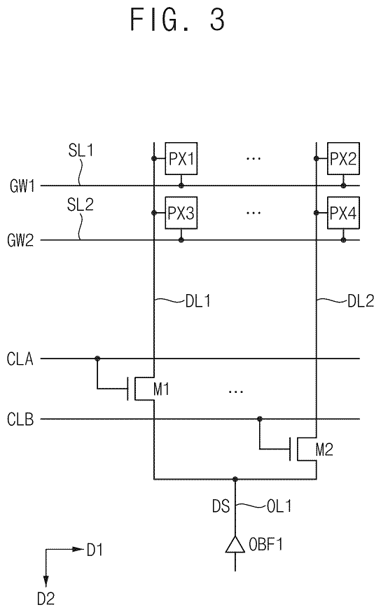

FIG. 3 is a schematic view showing a portion of the display device 100 of FIG. 1.

Referring to FIGS. 1 and 3, the display panel 110 may include a first scan line SL1, a second scan line SL2, a first data line DL1, a second data line DL2, a first pixel PX1, a second pixel PX2, a third pixel PX3, and a fourth pixel PX4.

The first and second scan lines SL1 and SL2 may extend in the first direction D1. The second scan line SL2 may be adjacent to the first scan line SL1 in the second direction D2. For example, no other scan line may be disposed between the first scan line SL1 and the second scan line SL2. The first scan line SL1 and the second scan line SL2 may transmit a first scan signal GW1 and a second scan signal GW2, respectively.

The first and second data lines DL1 and DL2 may extend in the second direction D2. In an embodiment, the second data line DL2 may be spaced apart from the first data line DL1 in the first direction D1. For example, another data line may be disposed between the first data line DL1 and the second data line DL2. In another embodiment, the second data line DL2 may be adjacent to the first data line DL1 in the first direction D1.

The first pixel PX1 may be connected to the first scan line SL1 and the first data line DL1. The second pixel PX2 may be connected to the first scan line SL1 and the second data line DL2. The third pixel PX3 may be connected to the second scan line SL2 and the first data line DL1. The fourth pixel PX4 may be connected to the second scan line SL2 and the second data line DL2. The first pixel PX1 and the second pixel PX2 may be positioned in an n^{th} (n is a natural number greater than 1) pixel row, and the third pixel PX3 and the fourth pixel PX4 may be positioned in an n+1^{th} pixel row.

In an embodiment, the first pixel PX1, the second pixel PX2, the third pixel PX3, and the fourth pixel PX4 may emit light having the same color. For example, each of the first pixel PX1, the second pixel PX2, the third pixel PX3, and the fourth pixel PX4 may emit red light, green light, or blue light.

The data driver 140 may include an output buffer OBF1. The output buffer OBF1 may output the data signal DS to an output line OL1.

The demultiplexer 150 may include a first transistor M1 and a second transistor M2. The first transistor M1 may be connected between the first data line DL1 and the output line OL1, and may be turned-on in response to a first control signal CLA. The second transistor M2 may be connected between the second data line DL2 and the output line OL1, and may be turned-on in response to a second control signal CLB.

The first transistor M1 may include a gate electrode receiving the first control signal CLA, a first electrode connected to the first data line DL1, and a second electrode connected to the output line OL1. The first transistor M1 may transmit the data signal DS to the first data line DL1 in response to the first control signal CLA having a turn-on voltage level.

The second transistor M2 may include a gate electrode receiving the second control signal CLB, a first electrode connected to the second data line DL2, and a second electrode connected to the output line OL1. The second transistor M2 may transmit the data signal DS to the second data line DL2 in response to the second control signal CLB having a turn-on voltage level.

In an embodiment, each of the first transistor M1 and the second transistor M2 may be an N-type transistor. In an embodiment, each of the first transistor M1 and the second transistor M2 may be an oxide semiconductor transistor.

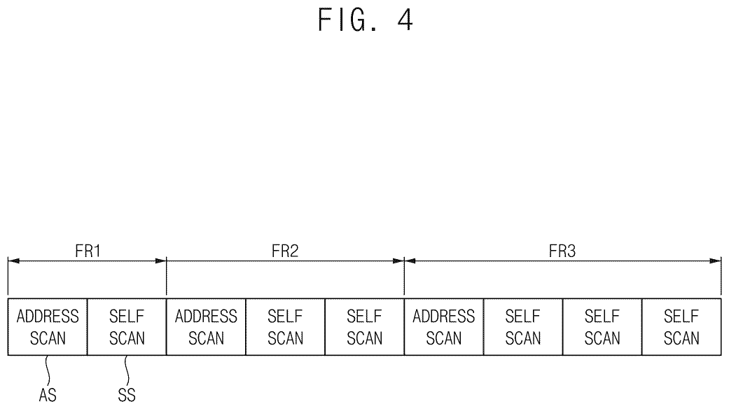

FIG. 4 is a schematic view for describing a method of driving the display device 100 of FIG. 1.

Referring to FIGS. 1 and 4, a frame period of the display device 100 may include an address scan period AS and at least one self-scan period SS. The address scan period AS may be defined as a period in which the data signals are applied to the data lines DL. In the address scan period AS, the display device 100 may display an image based on the data signals applied in the address scan period AS. The self-scan period SS may be defined as a period in which the data signals are not applied to the data lines DL. In the self-scan period SS, the display device 100 may display an image based on the data signals applied in the address scan period AS.

The display device 100 may change a driving frequency of the display device 100 by adjusting the number of self-scan periods SS included in the frame period. The driving frequency of the display device 100 may increase as the number of self-scan periods SS included in the frame period decreases, and the driving frequency of the display device 100 may decrease as the number of self-scan periods SS included in the frame period increases.

In an embodiment, as illustrated in FIG. 4, when a first frame period FR1 includes one self-scan period SS, a second frame period FR2 includes two self-scan periods SS, and a third frame period FR3 includes three self-scan periods SS, the driving frequency of the second frame period FR2 may be less than the driving frequency of the first frame period FR1, and the driving frequency of the third frame period FR3 may be less than the driving frequency of the second frame period FR2. For example, the driving frequency of the first frame period FR1 may be about 120 Hz, the driving frequency of the second frame period FR2 may be about 80 Hz, and the driving frequency of the third frame period FR3 may be about 60 Hz.

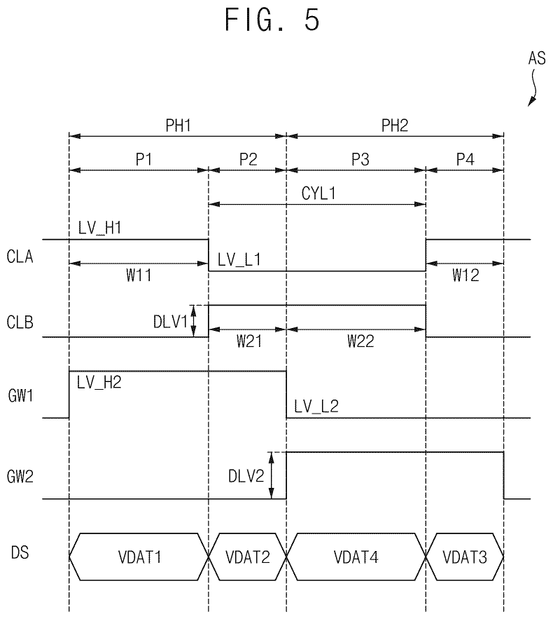

FIG. 5 is a timing diagram showing signals in the address scan period AS according to an embodiment.

Referring to FIGS. 2, 3, and 5, the first scan signal GW1 may have a turn-on voltage level LV_H2 in a first horizontal period PH1, and may have a turn-off voltage level LV_L2 in a second horizontal period PH2 after the first horizontal period PH1. Accordingly, the writing transistors T2 of the first and second pixels PX1 and PX2 may be turned-on in the first horizontal period PH1, and may be turned-off in the second horizontal period PH2.

The second scan signal GW2 may have the turn-off voltage level LV_L2 in the first horizontal period PH1, and may have the turn-on voltage level LV_H2 in the second horizontal period PH2. Accordingly, the writing transistors T2 of the third and fourth pixels PX3 and PX4 may be turned-off in the first horizontal period PH1, and may be turned-on in the second horizontal period PH2.

Each of the first and second control signals CLA and CLB may toggle between a turn-on voltage level LV_H1 and a turn-off voltage level LV_L1 with a first cycle (or first toggling duration CYL1) in the address scan period AS. For example, the first cycle may be substantially equal to a width of two horizontal periods, or the first toggling duration CYL1 may be substantially equal to a width of each horizontal period.

A period in which the first control signal CLA has the turn-on voltage level may not overlap a period in which the second control signal CLB has the turn-on voltage level. Accordingly, the first data line DL1 and the second data line DL2 may not be connected to the output line OL1 at the same time.

In a first period P1 of the first horizontal period PH1, the first control signal CLA may have the turn-on voltage level LV_H1, the second control signal CLB may have the turn-off voltage level LV_L1, and the output buffer BUF1 may output the data signal DS having a first data voltage VDAT1. Accordingly, in the first period P1, the first transistor M1 may be turned-on, the second transistor M2 may be turned-off, and the first data voltage VDAT1 may be applied to the first data line DL1. Therefore, in the first horizontal period PH1, the first data voltage VDAT1 may be written to the first pixel PX1.

In a second period P2 of the first horizontal period PH1, the first control signal CLA may have the turn-off voltage level LV_L1, the second control signal CLB may have the turn-on voltage level LV_H1, and the output buffer BUF1 may output the data signal DS having a second data voltage VDAT2. Accordingly, in the second period P2, the first transistor M1 may be turned-off, the second transistor M2 may be turned-on, and the second data voltage VDAT2 may be applied to the second data line DL2. Therefore, in the first horizontal period PH1, the second data voltage VDAT2 may be written to the second pixel PX2.

In a third period P3 of the second horizontal period PH2, the first control signal CLA may have the turn-off voltage level LV_L1, the second control signal CLB may have the turn-on voltage level LV_H1, and the output buffer BUF1 may output the data signal DS having a fourth data voltage VDAT4. Accordingly, in the third period P3, the first transistor M1 may be turned-off, the second transistor M2 may be turned-on, and the fourth data voltage VDAT4 may be applied to the second data line DL2. Therefore, in the second horizontal period PH2, the fourth data voltage VDAT4 may be written to the fourth pixel PX4.

In a fourth period P4 of the second horizontal period PH2, the first control signal CLA may have the turn-on voltage level LV_H1, the second control signal CLB may have the turn-off voltage level LV_L1, and the output buffer BUF1 may output the data signal DS having a third data voltage VDAT3. Accordingly, in the fourth period P4, the first transistor M1 may be turned-on, the second transistor M2 may be turned-off, and the third data voltage VDAT3 may be applied to the first data line DL1. Therefore, in the second horizontal period PH2, the third data voltage VDAT3 may be written to the third pixel PX3.

In an embodiment, a difference DLV1 between the turn-on voltage level LV_H1 and the turn-off voltage level LV_L1 of each of the first and second control signals CLA and CLB may be less than a difference DLV2 between the turn-on voltage level LV_H2 and the turn-off voltage level LV_L2 of each of the first and second scan signals GW1 and GW2. As the difference between a high voltage and a low voltage of a toggling signal decreases, power consumed by the signal may be reduced. The difference DLV1 between the turn-on voltage level LV_H1 and the turn-off voltage level LV_L1 of each of the first and second control signals CLA and CLB provided to the demultiplexer 150 may be less than the difference DLV2 between the turn-on voltage level LV_H2 and the turn-off voltage level LV_L2 of each of the first and second scan signals GW1 and GW2 output from the gate driver 120, power consumption of the demultiplexer 150 may be reduced.

In an embodiment, the turn-off voltage level LV_L1 of each of the first and second control signals CLA and CLB may be higher than the turn-off voltage level LV_L2 of each of the first and second scan signals GW1 and GW2. For example, the turn-off voltage level LV_L2 of each of the first and second scan signals GW1 and GW2 may be about-2.5 V, and the turn-off voltage level LV_L1 of each of the first and second control signals CLA and CLB may be higher than about-2.5 V.

In an embodiment, the turn-on voltage level LV_H1 of each of the first and second control signals CLA and CLB may be lower than the turn-on voltage level LV_H2 of each of the first and second scan signals GW1 and GW2. For example, the turn-on voltage level LV_H2 of each of the first and second scan signals GW1 and GW2 may be about 15 V, and the turn-on voltage level LV_H1 of each of the first and second control signals CLA and CLB may be lower than about 15 V.

In an embodiment, in the first horizontal period PH1, the second control signal CLB may have the turn-on voltage level LV_H1 after the first control signal CLA has the turn-on voltage level LV_H1, and in the second horizontal period PH2, the first control signal CLA may have the turn-on voltage level LV_H1 after the second control signal CLB has the turn-on voltage level LV_H1. As the number of toggles per unit time of a toggling signal decreases, power consumed by the signal may be reduced. In comparison with the prior art in which the second control signal CLB has the turn-on voltage level LV_H1 after the first control signal CLA has the turn-on voltage level LV_H1 in each horizontal period, in an embodiment, the second control signal CLB may have the turn-on voltage level LV_H1 after the first control signal CLA has the turn-on voltage level LV_H1 in the first horizontal period PH1, and the first control signal CLA may have the turn-on voltage level LV_H1 after the second control signal CLB has the turn-on voltage level LV_H1 in the second horizontal period PH2, and thus, the number of toggles per unit time may be reduced by about half, and the power consumption of the demultiplexer 150 may be reduced.

In an embodiment, in each of the first and second horizontal periods PH1 and PH2, a first width W11 and W12 of a period P1 and P4 in which the first control signal CLA has the turn-on voltage level LV_H1 may be different from a second width W21 and W22 of a period P2 and P3 in which the second control signal CLB has a turn-on voltage level LV_H1. For example, the first width W11 of the first period P1 may be different from the second width W21 of the second period P2, and the second width W22 of the third period P3 may be different from the first width W12 of the fourth period P4.

In an embodiment, in the first horizontal period PH1, the first width W11 of the first period P1 may be greater than the second width W21 of the second period P2. Since the first control signal CLA transitions from the turn-on voltage level LV_H1 to the turn-off voltage level LV_L1 at the end of the first period P1, a voltage level of the first data voltage VDAT1 may be lowered due to a kickback phenomenon, however, since the second control signal CLB does not transition at the end of the second period P2, the kickback phenomenon may not occur, and a voltage level of the second data voltage VDAT2 may not be lowered. Accordingly, in order to reduce a voltage deviation between the first and second data voltages VDAT1 and VDAT2, in the first horizontal period PH1, the first width W11 of the first period P1 in which the first control signal CLA has the turn-on voltage level LV_H1 may be greater than the second width W21 of the second period P2 in which the second control signal CLB has the turn-on voltage level LV_H1.

In an embodiment, in the second horizontal period PH2, the second width W22 of the third period P3 may be greater than the first width W12 of the fourth period P4. Since the second control signal CLB transitions from the turn-on voltage level LV_H1 to the turn-off voltage level LV_L1 at the end of the third period P3, a voltage level of the fourth data voltage VDAT4 may be lowered due to the kickback phenomenon, however, since the first control signal CLA does not transition at the end of the fourth period P4, the kickback phenomenon may not occur, and a voltage level of the third data voltage VDAT3 may not be lowered. Accordingly, in order to reduce a voltage deviation between the third and fourth data voltages VDAT3 and VDAT4, in the second horizontal period PH2, the second width W22 of the third period P3 in which the second control signal CLB has the turn-on voltage level LV_H1 may be greater than the first width W12 of the fourth period P4 in which the first control signal CLA has the turn-on voltage level LV_H1.

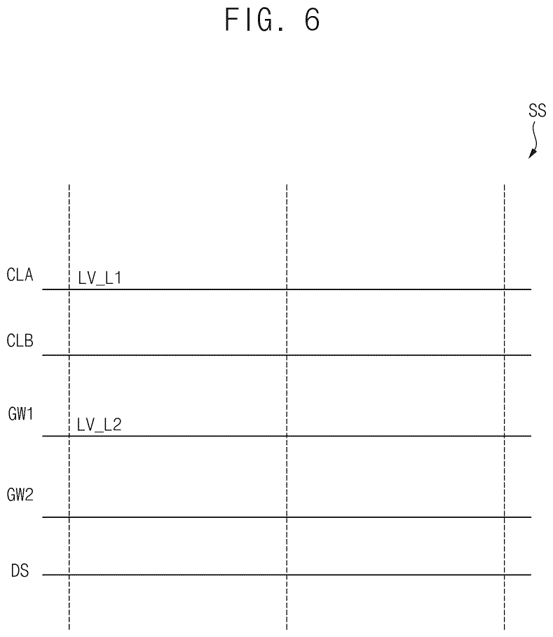

FIG. 6 is a timing diagram showing signals in the self-scan period SS according to an embodiment.

Referring to FIGS. 3 and 6, in an embodiment, each of the first and second control signals CLA and CLB may have the turn-off voltage level LV_L1 in the self-scan period SS. As the number of toggles per unit time of a toggling signal decreases, power consumed by the signal may decrease. Since the data signals DS are not applied to the first and second data lines DL1 and DL2 in the self-scan period SS, in the self-scan period SS, each of the first and second control signals CLA and CLB may have the turn-off voltage level LV_L1, and the first and second transistors M1 and M2 may be turned-off. Accordingly, the power consumption of the demultiplexer 150 to which the first and second control signals CLA and CLB are provided may be reduced.

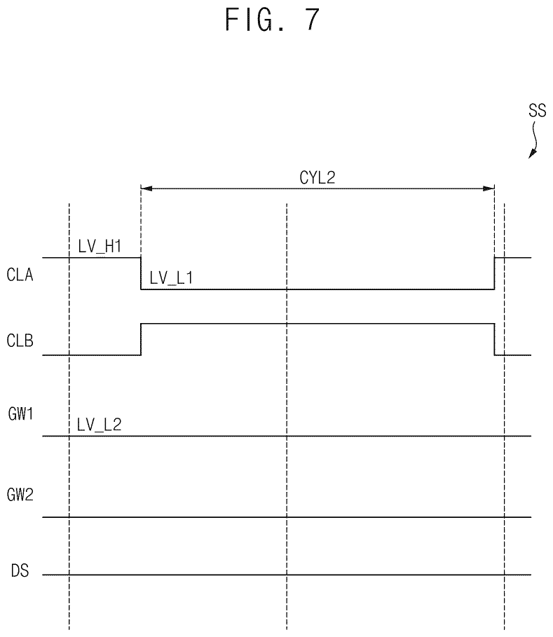

FIG. 7 is a timing diagram showing signals in the self-scan period SS according to an embodiment.

Referring to FIGS. 3 and 7, in an embodiment, each of the first and second control signals CLA and CLB may toggle between the turn-on voltage level LV_H1 and the turn-off voltage level LV_L1 with a second cycle (or second toggling duration CYL2) in the self-scan period SS. The second toggling duration CYL2 may be greater than the first toggling duration CYL1 in which each of the first and second control signals CLA and CLB toggles in the address scan period AS. As the number of toggles per unit time of a toggling signal decreases, power consumed by the signal may be reduced. As the number of toggles per unit time of the first and second control signals CLA and CLB decreases in the self-scan period SS, the power consumption of the demultiplexer 150 to which the first and second control signals CLA and CLB are provided may be reduced.

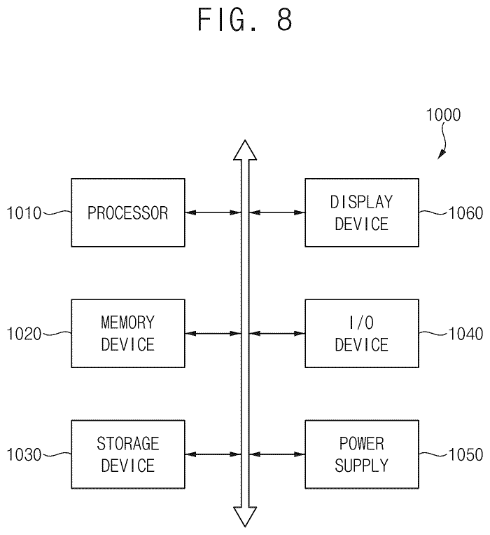

FIG. 8 is a block diagram showing an electronic apparatus according to an embodiment.

Referring to FIG. 8, an electronic apparatus 1000 may include a processor 1010, a memory device 1020, a storage device 1030, an input/output (I/O) device 1040, a power supply 1050, and a display device 1060. The electronic apparatus 1000 may further include ports capable of communicating with a video card, a sound card, a memory card, a USB device, and the like, or communicating with other systems.

The processor 1010 may perform specific calculations or tasks. According to an embodiment, the processor 1010 may be a microprocessor, a central processing unit (CPU), or the like. The processor 1010 may be connected to other components through an address bus, a control bus, a data bus, and the like. According to an embodiment, the processor 1010 may also be connected to an expansion bus such as a peripheral component interconnect (PCI) bus. The processor 1010 may control the display device 1060.

The processor 1010 may control the display device 1060. In an embodiment, the processor 1010 may provide the first image data IMD1 of FIG. 1 and the controller control signal CNT of FIG. 1 to the display device 1060.

The memory device 1020 may store data required for an operation of the electronic apparatus 1000. For example, the memory device 1020 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

The storage device 1030 may include a solid state drive (SSD), a hard disk drive (HDD), a CD-ROM, and the like. The I/O device 1040 may include: an input device such as a keyboard, a keypad, a touch pad, a touch screen, or a mouse; and an output device such as a speaker or a printer. The power supply 1050 may supply a power required for the operation of the electronic apparatus 1000. The display device 1060 may display an image. The display device 1060 may be connected to other components through the buses or other communication links. The display device 1060 may correspond to the display device 100 of FIG. 1.

The electronic apparatus 1000 may include televisions, notebook computers, monitors, advertisement boards, Internet of things (IoTs), portable electronic apparatuses including mobile phones, smartphones, tablet personal computers (PCs), mobile communication terminals, electronic organizers, electronic books, portable multimedia players (PMPs), navigations, ultra mobile personal computers (UMPCs), smartwatches, watchphones, glasses-type displays, head-mounted displays (HMDs), instrument panels for automobiles, center fascias for automobiles, or center information displays (CIDs) on a dashboard, room mirror displays of automobiles, and displays of an entertainment system on a backside of front seats in automobiles.

In the display device 1060, a difference between a turn-on voltage level and a turn-off voltage level of first and second control signals provided to a demultiplexer may decrease, the order in which the first and second control signals have the turn-on voltage level may alternately change in units of horizontal periods, or, in a self-scan period, the first and second control signals may have the turn-off voltage level or a toggling duration of the first and second control signals may increase, and thus, power consumption of the demultiplexer may be reduced, and power consumption of the display device 1060 may be reduced.

The display device according to the embodiments may be applied to a display device included in a computer, a notebook, a mobile phone, a smart phone, a smart pad, a smart watch, a PMP, a PDA, an MP3 player, or the like.

In concluding the detailed description, those skilled in the art will appreciate that many variations and modifications may be made to the embodiments without substantially departing from the principles and spirit and scope of the disclosure. Therefore, the disclosed embodiments are used in a generic and descriptive sense only and not for purposes of limitation.

What is claimed is:

1. A display device comprising:
a first pixel connected to a first scan line which transmits a first scan signal and a first data line;
a second pixel connected to the first scan line and a second data line;
a data driver including an output buffer which outputs a data signal to an output line; and
a demultiplexer including a first transistor connected between the first data line and the output line and turned-on in response to a first control signal, and a second transistor connected between the second data line and the output line and turned-on in response to a second control signal,
wherein a difference between a turn-on voltage level and a turn-off voltage level of each of the first and second control signals is less than a difference between a turn-on voltage level and a turn-off voltage level of the first scan signal.

2. The display device of claim 1, wherein the turn-off voltage level of each of the first and second control signals is higher than the turn-off voltage level of the first scan signal.

3. The display device of claim 1, wherein the turn-on voltage level of each of the first and second control signals is lower than the turn-on voltage level of the first scan signal.

4. The display device of claim 1, wherein
a frame period includes an address scan period in which the data signal is applied to the first and second data lines, and a self-scan period in which the data signal is not applied to the first and second data lines, and
each of the first and second control signals toggles between the turn-on voltage level and the turn-off voltage level with a first toggling duration in the address scan period.

5. The display device of claim 4, wherein each of the first and second control signals has the turn-off voltage level in the self-scan period.

6. The display device of claim 4, wherein each of the first and second control signals toggles between the turn-on voltage level and the turn-off voltage level with a second toggling duration greater than the first toggling duration in the self-scan period.

7. The display device of claim 1, further comprising:
a third pixel connected to a second scan line which transmits a second scan signal and the first data line; and
a fourth pixel connected to the second scan line and the second data line, wherein,
in a first horizontal period in which the first scan signal has the turn-on voltage level, the second control signal has the turn-on voltage level after the first control signal has the turn-on voltage level, and
in a second horizontal period in which the second scan signal has a turn-on voltage level, the first control signal has the turn-on voltage level after the second control signal has the turn-on voltage level.

8. The display device of claim 7, wherein, in each of the first and second horizontal periods, a first width of a period in which the first control signal has the turn-on voltage level is different from a second width of a period in which the second control signal has the turn-on voltage level.

9. The display device of claim 8, wherein the first width is greater than the second width in the first horizontal period.

10. The display device of claim 9, wherein the second width is greater than the first width in the second horizontal period.

11. The display device of claim 1, wherein a period in which the first control signal has the turn-on voltage level does not overlap a period in which the second control signal has the turn-on voltage level.

12. The display device of claim 1, wherein each of the first and second pixels includes:
a driving transistor including a gate electrode connected to a first node, a first electrode connected to a second node, and a second electrode connected to a third node;
a writing transistor including a gate electrode which receives a first scan signal, a first electrode which receives the data signal, and a second electrode connected to the first node;
a reference transistor including a gate electrode which receives a reference gate signal, a first electrode which receives a reference voltage, and a second electrode connected to the first node;
an initialization transistor including a gate electrode which receives an initialization gate signal, a first electrode which receives an initialization voltage, and a second electrode connected to the third node;
an emission transistor including a gate electrode which receives an emission signal, a first electrode which receives a first power voltage, and a second electrode connected to the second node;
a storage capacitor including a first electrode connected to the first node and a second electrode connected to the third node;
a hold capacitor including a first electrode which receives the first power voltage and a second electrode connected to the third node; and
a light-emitting element including a first electrode connected to the third node and a second electrode which receives a second power voltage.

13. A display device comprising:
a first pixel connected to a first scan line which transmits a first scan signal and a first data line;
a second pixel connected to the first scan line and a second data line;
a third pixel connected to a second scan line which transmits a second scan signal and the first data line;
a fourth pixel connected to the second scan line and the second data line;
a data driver including an output buffer which outputs a data signal to an output line; and
a demultiplexer including a first transistor connected between the first data line and the output line and turned-on in response to a first control signal, and a second transistor connected between the second data line and the output line and turned-on in response to a second control signal, wherein
in a first horizontal period in which the first scan signal has a turn-on voltage level, the second control signal has a turn-on voltage level after the first control signal has a turn-on voltage level, and
in a second horizontal period in which the second scan signal has a turn-on voltage level, the first control signal has the turn-on voltage level after the second control signal has the turn-on voltage level.

14. The display device of claim 13, wherein
a frame period includes an address scan period in which the data signal is applied to the first and second data lines, and a self-scan period in which the data signal is not applied to the first and second data lines, and
each of the first and second control signals toggles between the turn-on voltage level and a turn-off voltage level with a first toggling duration in the address scan period.

15. The display device of claim 14, wherein each of the first and second control signals has the turn-off voltage level in the self-scan period.

16. The display device of claim 14, wherein each of the first and second control signals toggles between the turn-on voltage level and the turn-off voltage level with a second toggling duration greater than the first toggling duration in the self-scan period.

17. The display device of claim 13, wherein, in each of the first and second horizontal periods, a first width of a period in which the first control signal has the turn-on voltage level is different from a second width of a period in which the second control signal has the turn-on voltage level.

18. The display device of claim 17, wherein the first width is greater than the second width in the first horizontal period.

19. The display device of claim 18, wherein the second width is greater than the first width in the second horizontal period.

20. An electronic apparatus comprising:
a display device which displays an image; and
a processor which controls the display device, wherein
the display device comprises:
a first pixel connected to a first scan line which transmits a first scan signal and a first data line;
a second pixel connected to the first scan line and a second data line;
a data driver including an output buffer which outputs a data signal to an output line; and
a demultiplexer including a first transistor connected between the first data line and the output line and turned-on in response to a first control signal, and a second transistor connected between the second data line and the output line and turned-on in response to a second control signal,
a difference between a turn-on voltage level and a turn-off voltage level of each of the first and second control signals is less than a difference between a turn-on voltage level and a turn-off voltage level of the first scan signal.
